(19) United States
(12) Patent Application Publication
(10) Pub. No.: US 2022/0339553 A1
(43) Pub. Date: Oct. 27, 2022

(54) COMPOSITIONS AND METHODS FOR REMEDIATION OF PESTICIDES AND HEAVY METALS FROM BIOMASS EXTRACTS

(71) Applicant: Armand J. Noel, Tempe, AZ (US)

(72) Inventor: Armand J. Noel, Tempe, AZ (US)

(21) Appl. No.: 17/660,465

(22) Filed: Apr. 25, 2022

Related U.S. Application Data
(60) Provisional application No. 63/179,878, filed on Apr. 26, 2021.

(51) Int. Cl. B01D 11/02; A23L 33/105; A23L 5/20; B01D 15/08; B01D 15/02

(52) U.S. Cl. CPC B01D 11/0203; A23L 33/105; A23L 5/23; A23L 5/273; B01D 15/08; B01D 11/0288; B01D 15/02; A23V 2002/00

(57) ABSTRACT

Some variations provide a remediation composition for pesticide and/or heavy-metal remediation of a biomass extract, the remediation composition comprising at least one polysaccharide, at least one metal oxide, and at least one metal salt. Some variations provide a process for producing a biomass extract from a biomass feedstock, comprising: providing a starting biomass feedstock that contains a pesticide or a heavy metal; exposing the starting biomass feedstock to a process solvent, thereby forming a biomass extract dissolved and/or suspended in the process solvent, wherein the pesticide or heavy metal are contained in the biomass extract; providing a separation media containing a polysaccharide, a metal oxide, and a metal salt; and introducing the biomass extract to the separation media, wherein the pesticide or the heavy metal are removed by the separation media, thereby generating a remediated biomass extract. Systems utilizing the remediation composition in fixed or fluidized beds are described.

### PRIORITY DATA

This non-provisional patent application claims priority to U.S. Provisional Patent App. No. 63/179,878, filed on Apr. 26, 2021, which is hereby incorporated by reference herein.

### FIELD OF THE INVENTION

The present invention generally relates to compositions and methods for removing pesticides and/or heavy metals from biomass extracts, and remediated products produced therefrom.

### BACKGROUND OF THE INVENTION

Biomass extracts are important agricultural products. A biomass extract may be a herbal ingredient with desirable flavor, aroma, or nutritive quality that is removed from the tissue of a plant, usually by treating it with a solvent. Biomass extracts have been used as a source of medicine throughout history and continue to serve as the basis for many pharmaceuticals, cosmeceuticals, and nutraceuticals today. Valuable biomass extracts include, but are by no means limited to, hemp, hops, chamomile, dandelion, echinacea, marigold, lavender, and many other therapeutic plants and herbs.

Solvent extractions of botanical oils have occurred for centuries. Most early applications employed the use of commonly available oils like olive oil and vegetable oils, based on direct contact of the oil with the plant material or seeds of the desired oil. These were used in early medicine, food enhancements, and preservatives. This conventional process was very inefficient and only a minor portion of the plant's compounds were transferred to the oil carrier. Steam stripping was later used and proved to be more efficient. Steam extractions are widely used today. However, the high temperatures of the steam stripping cycle damage many targeted compounds. For these and other reasons, solvents employed in biomass extraction are often non-polar solvents.

A pesticide is any substance used to kill, repel, or control certain forms of plant or animal life that are considered to be pests. Pesticides include herbicides for destroying weeds and other unwanted vegetation, insecticides for controlling a wide variety of insects, fungicides used to prevent the growth of molds and mildew, bactericides for preventing the spread of bacteria, and rodenticides used to control mice and rats, and larvicides primary used to control mosquitoes.

Pesticides are widely used in most sectors of agricultural production to prevent or reduce losses by pests and thus can improve yield as well as quality of agricultural products. Despite their popularity and extensive use, pesticides raise serious concerns about health risks arising from the consumption of agricultural products or from extracts obtained from agricultural products. By their very nature, most pesticides show a high degree of toxicity because they are designed to kill certain organisms and thus create some risk of harm. See Damalas et al., “Pesticide Exposure, Safety Issues, and Risk Assessment Indicators”, Int. J. Environ. Res. Public Health 2011, 8, 1402-1419, which is hereby incorporated by reference herein. Also see Environmental Protection Agency regulations and guidance regarding pesticides at www.epa.gov/pesticides, retrieved Apr. 13, 2022, which is hereby incorporated by reference including all contents linked therein.

Chemical pesticides include organophosphates, carbamates, organochlorine compounds, pyrethroids, and sulfonylurea compounds. Specific examples of chemical pesticides are glyphosate, acephate, diethyltoluamide, propoxur, metaldehyde, boric acid, diazinon, chlorpyrifos, malathion, dichloro-diphenyl-trichloroethane, chlordane, toxaphene, imazosulfuron, oxasulfuron, nicosulfuron, and flazasulfuron, to name just a few.

Some heavy metals also pose a serious threat to human health. Some heavy metals are either essential nutrients, such as iron (Fe), cobalt (Co), and zinc (Zn), or are relatively harmless. Other heavy metals, such as cadmium (Cd), arsenic (As), mercury (Hg), and lead (Pb), are highly poisonous when consumed, and the United States Food and Drug Administration (FDA) provides guidance on these heavy metals. Heavy metals are commonly found in the environment, especially in areas that are near mines or industrial sites. These metals can contaminate soil and ultimately end up in growing biomass, especially when soil pH is relatively low. Chemical fertilizers that are high in phosphates can also be a source of heavy metals.

Many extractable agricultural products unavoidably have a problem with pesticides and heavy metals leeching into the plants when they absorb water from the ground. Once plants absorb the pesticides into their stems or stalks, the pesticides will remain there, only to be removed when processors subject the plants to extraction for extracting out certain compounds. As mentioned above, processors typically employ non-polar solvents, or a combination of polar and non-polar organic solvents, to achieve the desired extraction. Most pesticides themselves are non-polar in nature. Therefore, when exposed to the extraction solvent, many pesticides are also extracted out of the plant and into the extract solution.

For many industries, contamination of commercial products with pesticides is a monumental problem. Growing products organically without the use of pesticides is one option. However, most of the farmland utilized in the present time has been farmed at least once with pesticides at some point in its history. If pesticides were ever used in the past, the ground water is most likely contaminated with these past pesticides, and the vegetation being grown currently still has a high likelihood of absorbing pesticide-contaminated ground water.

There remains a need in the art to economically remove pesticides and heavy metals from biomass extracts, agricultural products, or other products.

### SUMMARY OF THE INVENTION

The present invention addresses the aforementioned needs in the art, as will now be summarized and then further described in detail below.

Some variations of the invention provide a remediation composition for pesticide and/or heavy-metal remediation of a biomass extract, the remediation composition comprising:

at least one polysaccharide;

at least one metal oxide; and

at least one metal salt.

In some embodiments, the remediation composition consists essentially of at least one polysaccharide, at least one metal oxide, and at least one metal salt.

In some embodiments, the remediation composition comprises from about 2 wt % to about 40 wt % of at least one polysaccharide, such as from about 5 wt % to about 35 wt % of at least one polysaccharide, about 10 wt % to about 30 wt % of at least one polysaccharide, or about 17 wt % to about 27 wt % of at least one polysaccharide. These weight percentages are for the total polysaccharide concentration present in the remediation composition, i.e. counting all polysaccharides in aggregate.

In some embodiments, the remediation composition comprises from about 3 wt % to about 60 wt % of at least one metal oxide, such as from about 10 wt % to about 50 wt % of at least one metal oxide, or from about 20 wt % to about 45 wt % of at least one metal oxide, or from about 28 wt % to about 40 wt % of at least one metal oxide. These weight percentages are for the total metal oxide concentration present in the remediation composition, i.e. counting all metal oxides in aggregate.

In certain embodiments, there are at least two distinct metal oxides in the remediation composition. In these embodiments, the remediation composition may comprise from about 0.1 wt % to about 60 wt % of each metal oxide, such as from about 5 wt % to about 50 wt % of each metal oxide, or from about 10 wt % to about 25 wt % of each metal oxide. The concentration of each metal oxide may be independently selected.

In some embodiments, the remediation composition comprises from about 4 wt % to about 80 wt % of at least one metal salt, such as from about 10 wt % to about 75 wt % of at least one metal salt, or from about 25 wt % to about 65 wt % of at least one metal salt, or from about 34 wt % to about 54 wt % of at least one metal salt. These weight percentages are for the total metal salt concentration present in the remediation composition, i.e. counting all metal salts in aggregate.

In some embodiments, at least one polysaccharide is chitosan. In these or other embodiments, at least one metal oxide is magnesium oxide. In some embodiments, at least one metal oxide is aluminum oxide. In some embodiments, at least one metal oxide is silicon oxide. In certain embodiments, there are at least two metal oxides including magnesium oxide and aluminum oxide. In certain embodiments, there are at least two metal oxides including magnesium oxide and silicon oxide. In certain embodiments, there are at least three metal oxides including magnesium oxide, aluminum oxide, and silicon oxide. In these or other embodiments, at least one metal salt is sodium sulfate.

Some variations of the invention provide a remediation composition for pesticide and/or heavy-metal remediation of a biomass extract, the remediation composition comprising:

at least one polysaccharide;

at least one metal oxide, and optionally at least two distinct metal oxides; and

sodium sulfate.

Some variations of the invention provide a remediation composition for pesticide and/or heavy-metal remediation of a biomass extract, the remediation composition comprising:

chitosan;

magnesium oxide;

aluminum oxide; and

at least one metal salt.

Some variations of the invention provide a remediation composition for pesticide and/or heavy-metal remediation of a biomass extract, the remediation composition comprising:

chitosan;

magnesium oxide;

aluminum oxide; and

sodium sulfate.

Some variations of the invention provide a separation media comprising a remediation composition as disclosed herein. The separation media may consist essentially of the remediation composition. Alternatively, the separation media may further comprise an inert material. Alternatively, or additionally, the separation media may further comprise a support material. Alternatively, or additionally, the separation media may further comprise a spacer material.

The biomass extract that is remediated by the remediation composition may be a hemp extract or a hops extract, for example.

Some variations provide a process for producing a biomass extract from a biomass feedstock, the process comprising:

(a) providing a starting biomass feedstock, wherein the starting biomass feedstock contains at least one pesticide or at least one heavy metal;

(b) exposing the starting biomass feedstock to a process solvent, thereby forming a biomass extract and residual solids, wherein the biomass extract is dissolved and/or suspended in the process solvent, and wherein at least one pesticide or at least one heavy metal are contained in the biomass extract;

(c) providing a separation media comprising a remediation composition containing at least one polysaccharide, at least one metal oxide, and at least one metal salt;

(d) introducing the biomass extract to the separation media, wherein at least one pesticide or at least one heavy metal is at least partially removed by the separation media via adsorption, absorption, precipitation, reaction, or a combination thereof, thereby generating a remediated biomass extract; and

(e) recovering the remediated biomass extract.

In some embodiments, the process solvent is a non-polar solvent, such as a hydrocarbon or supercritical carbon dioxide.

In some embodiments, the separation media is introduced to an extraction reactor configured for carrying out step (b). In these or other embodiments, the separation media is introduced to a separation unit that is distinct from an extraction reactor configured for carrying out step (b). The separation media may form a fixed bed within the separation unit. A fixed bed may be a packed bed of the separation media or structured packing, for example.

Step (d) may be conducted in the presence of at least a portion of the residual solids. In some embodiments, step (d) is conducted in the absence of the residual solids. Step (d) may be continuous or semi-continuous.

In some processes, at least one pesticide or at least one heavy metal is at least 90% removed by the separation media. Preferably, at least one pesticide or at least one heavy metal is at least 99% removed by the separation media. More preferably, at least one pesticide or at least one heavy metal is completely removed by the separation media. In some embodiments, at least one pesticide and at least one heavy metal is at least 90%, at least 99%, or completely removed by the separation media.

The remediation composition utilized in the process may be any one of the compositions disclosed herein. The separation media utilized in the process may be any one of the separation media disclosed herein.

In some processes, the starting biomass feedstock is hemp. In some processes, the starting biomass feedstock is hops. Many other feedstocks may be processed, as described in the detailed description.

Some variations of the invention provide a system for producing a biomass extract from a biomass feedstock, the system comprising:

an extraction reactor configured for exposing a starting biomass feedstock to a process solvent, thereby forming a biomass extract and residual solids, wherein the starting biomass feedstock contains at least one pesticide or at least one heavy metal;

a separation unit containing a separation media, wherein the separation unit is in flow communication with the extraction reactor, wherein the separation media comprises a remediation composition containing at least one polysaccharide, at least one metal oxide, and at least one metal salt, and wherein the separation media is capable of at least partially removing at least one pesticide or at least one heavy metal; and

an outlet for recovering the biomass extract.

In some systems, the separation media is configured as a fixed bed within the separation unit. The fixed bed may be a packed bed of the separation media. Alternatively, or additionally, the fixed bed may be structured packing of the separation media.

The remediation composition utilized in the system may be any one of the compositions disclosed herein. The separation media utilized in the system may be any one of the separation media disclosed herein.

In some systems, the starting biomass feedstock is hemp. In some systems, the starting biomass feedstock is hops. Many other feedstocks may be introduced to the system, as described in the detailed description. After the system has been operated for a period of time, the separation media may contain at least one pesticide or at least one heavy metal in adsorbed, absorbed, precipitated, and/or reacted form.

Other variations of the invention provide a system for producing a biomass extract from a biomass feedstock, the system comprising:

an extraction reactor configured for exposing a starting biomass feedstock to a process solvent, thereby forming a biomass extract and residual solids, wherein the starting biomass feedstock contains at least one pesticide or at least one heavy metal;

separation media contained within the extraction reactor, wherein the separation media comprises a remediation composition containing at least one polysaccharide, at least one metal oxide, and at least one metal salt, and wherein the separation media is capable of at least partially removing at least one pesticide or at least one heavy metal; and

an outlet for recovering the biomass extract.

In some systems, the separation media is configured as a fixed bed within the extraction reactor. The fixed bed may be a packed bed of the separation media. Alternatively, or additionally, the fixed bed may be structured packing of the separation media. The separation media may be contained within the extraction reactor in another form that is not a fixed bed—for example, within walls of the reactor, within a separation-media basket, or as a slurry. Alternatively, the separation media may be contained within the extraction reactor in the form of a fluidized bed.

The remediation composition utilized in the system may be any one of the compositions disclosed herein. The separation media utilized in the system may be any one of the separation media disclosed herein.

In some systems, the starting biomass feedstock is hemp. In some systems, the starting biomass feedstock is hops. Many other feedstocks may be introduced to the system, as described in the detailed description. After the system has been operated for a period of time, the separation media may contain at least one pesticide or at least one heavy metal in adsorbed, absorbed, precipitated, and/or reacted form.

The present invention also provides a remediation method for removing pesticides and/or heavy-metals from a biomass extract, the method comprising:

(a) providing a biomass extract, wherein the biomass extract contains at least one pesticide or at least one heavy metal;

(b) providing a separation media comprising a remediation composition containing at least one polysaccharide, at least one metal oxide, and at least one metal salt;

(c) introducing the separation media to a separation unit;

(d) feeding the biomass extract through the separation unit, wherein at least one pesticide or at least one heavy metal is at least partially removed by the separation media via adsorption, absorption, precipitation, reaction, or a combination thereof, thereby generating a remediated biomass extract; and

(e) recovering the remediated biomass extract from the separation unit.

In some methods, the biomass extract is obtained from a prior process of extracting a starting biomass feedstock utilizing a process solvent. In some embodiments, the biomass extract in step (a) is dissolved in an extract solvent consisting essentially of the process solvent. In other embodiments, the biomass extract in step (a) is dissolved in an extract solvent that is different than the process solvent. The extract solvent may be a non-polar solvent, such as a hydrocarbon or supercritical carbon dioxide.

The separation media may form a fixed bed or a fluidized bed within the separation unit. A fixed bed may be a packed bed of the separation media. Alternatively, or additionally, a fixed bed may be structured packing of the separation media. In certain embodiments, a fluidized bed utilizes carbon dioxide as a fluidizing medium.

Step (d) may comprise continuously or semi-continuously feeding the biomass extract through the separation unit.

In some methods, at least one pesticide or at least one heavy metal is at least 90% removed by the separation media. Preferably, at least one pesticide or at least one heavy metal is at least 99% removed by the separation media. More preferably, at least one pesticide or at least one heavy metal is completely removed by the separation media. In certain methods, at least one pesticide and at least one heavy metal is at least 90%, at least 99%, or completely removed by the separation media.

In the remediation method, the remediation composition utilized may be any one of the compositions disclosed herein. The separation media utilized in the remediation method may be any one of the separation media disclosed herein. Exemplary biomass extracts include, but are by no means limited to, hemp extracts and hops extracts.

The present invention also provides a remediation system for removing pesticides and/or heavy-metals from a biomass extract, the system comprising:

a separation unit containing a separation media, wherein the separation media comprises a remediation composition containing at least one polysaccharide, at least one metal oxide, and at least one metal salt;

an inlet for feeding the biomass extract through the separation unit, wherein the separation media is capable of at least partially removing at least one pesticide or at least one heavy metal; and

an outlet for recovering the biomass extract, wherein the outlet is disposed distally from the inlet.

The separation media may form a fixed bed or a fluidized bed within the separation unit of the system. A fixed bed may be a packed bed of the separation media. Alternatively, or additionally, a fixed bed may be structured packing of the separation media. In certain embodiments, a fluidized bed utilizes carbon dioxide as a fluidizing medium for the separation media within the separation unit.

In the remediation system, the remediation composition present may be any one of the compositions disclosed herein. The separation media present in the remediation system may be any one of the separation media disclosed herein.

When the system is being operated, the system will contain a biomass extract such as, but not limited to, a hemp extract or a hops extract.

After the system has been operated for a period of time, the separation media may contain at least one pesticide or at least one heavy metal in adsorbed, absorbed, precipitated, and/or reacted form.

### BRIEF DESCRIPTION OF THE FIGURES

FIG. 1 depicts the process of some embodiments in which a remediation composition is contained within an extraction vessel.

FIG. 2 depicts the process of some embodiments in which a remediation composition is contained within a separation vessel that is downstream of an extraction vessel.

FIG. 3 depicts the process of some embodiments in which large supercritical carbon dioxide extractors and two media vessels loaded with the remediation composition are utilized.

### DETAILED DESCRIPTION OF EMBODIMENTS OF THE INVENTION

The compositions, methods, and systems of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

Variations of the invention are predicated on the discovery of a surprisingly effective remediation composition for the removal of pesticides and/or heavy metals from biomass extracts.

In this disclosure, “heavy metals” refer to chromium, arsenic, cadmium, mercury, and lead. Pesticides include compounds that the U.S. Environmental Protection Agency considers a pesticide (see www.epa.gov/pesticides, which is hereby incorporated by reference herein). Pesticides that may be removed by the remediation composition include, but are not limited to, Abamectin, Acephate, Acequinocyl, Acetamiprid, Aldicarb, Azoxystrobin, Bifenazate, Bifenthrin, Boscali, Captan, Carbaryl, Carbofuran, Chlorantraniliprole, Chlordane, Chlorfenapyr, Chlorpyrifos, Clofentezine, Coumaphos, Cyfluthrin, Cypermethrin, Daminozide, DDVP (Dichlorvous), Diazinon, Dimethoate, Dimethomorph, Ethoprop(hos), Etofenprox, Etoxazole, Fenhexamid, Fenoxycarb, Fenpyroximate, Fipronil, Flonicamid, Fludioxanil, Hexythiazox, Imazalil, Imidacloprid, Kresoxim Methyl, Malathion, Metalaxyl, Methiocarb, Methomyl, Methyl Parathion, Mevinphos, Myclobutanil, Naled, Oxamyl, Paclobutrazol, Pentachloronitrobenzene, Permethrins, Phosmet, Piperonyl Butoxide, Prallethrin, Propiconazole, Propoxur, Pyrethrins, Pyridaben, Spinetoram, Spinosad, Spiromesifen, Spirotetramat, Spiroxamine, Tebuconazole, Thiaclorprid, Thiamethoxam, Trifloxystrobin, Acetochlor, Alachlor, Aldicarb Sulfone, Aldicarb Sulfoxide, Aldrin, Atrazine, Benfluralin, BHC-α, BHC-β, Bitertanol, Buprofezin, Carbendazim (MBC), Carfentrazone Ethyl, Chlorobenzilate, Chlorotoluron, Chlorpropham, Chlorpyrifos Methyl, Chlorthiophos, Clethodim, Clomazone, Clothianidin, Cyazofamid, Cymoxanil, Cyprodinil, Cyromazine, DCPA (Dacthal), Diallate, Dieldrin, Diflubenzuron, Dimethachlor, Diniconazole, Dinotefuran, Diphenamid, Diphenylamine (DPA), Diuron, Esfenvalerate, Ethalfluralin, Ethylan, Etridazole, Fenarimol, Fenbuconazole, Fenpropimorph, Fenthion, Fenvalerate, Fluazifop-P-butyl, Flubendiamide, Fluchloralin, Flucythrinate, Fluoxastrobin, Flusilazole, Flutolanil, Flutriafol, Fonofos, Formetanate Hydrochloride, Heptachlor, Hexachlorobenzene, Hexaconazole, Hexazinone, 3-Hydroxycarbofuran, Indoxacarb, Isazophos, Isopropalin, Isoproturon, Lindane, Linuron, Mandipropamid, Methamidophos, Methoxychlor, 4-4′-Methoxychlor Olefin, Methoxyfenozide, Metolachlor, MGK 264, Mirex, Novaluron, 5-OH Thiabendazole, Omethoate, Oxadiazon, Oxyflourfen, Parathion, Pebulate, Penconazole, Pendimethalin, Pentachloroaniline, Pentachloroanisole, Pentachlorobenzene, Pentachlorobenzonitrile, 2-Phenylphenol, Pirimicarb, Pirimiphos Ethyl, Pirimiphos Methyl, Pretilachlor, Prochloraz, Procymidone, Propamocarb, Propargite, Propisochlor, Propyzamide, Prothiofos, Pymetrozine, Pyraclostrobin, Pyrimethanil, Pyriproxyfen, Quinalphos, Quintozene, Sulfentrazone, Sulfotep, Tau-Fluvalinate, Tebufenozide, Tecnazene, Tefluthrin, Terbutylazine, Tetrachloroaniline, Tetradifon, Thiobencarb, Tolclofos Methyl, Transfluthrin, Triadimefon, Triallate, Trichlorfon, Tricyclazole, Triflumizole, Trifluralin, Vamidothion, Vinclozolin, derivatives or analogs thereof, or combinations of the foregoing.

The concentration of some pesticides found in biomass feedstocks are so low that analytical instruments typically cannot quantify them, even though they are indeed present. However, when a biomass feedstock goes through an extraction process, extractable components are concentrated relative to the starting material. This concentration increase leads to many pesticides being detectible even when those pesticides were below analytical detection limits in the starting biomass feedstock. Detectible levels of pesticides in biomass extracts are problematic commercially.

Some variations of the invention provide a remediation composition for pesticide and/or heavy-metal remediation of a biomass extract, the remediation composition comprising:

at least one polysaccharide;

at least one metal oxide; and

at least one metal salt.

In some embodiments, the remediation composition consists essentially of at least one polysaccharide, at least one metal oxide, and at least one metal salt.

In some embodiments, the remediation composition comprises from about 2 wt % to about 40 wt % of at least one polysaccharide, such as from about 5 wt % to about 35 wt % of at least one polysaccharide, or from about 10 wt % to about 30 wt % of at least one polysaccharide, or from about 17 wt % to about 27 wt % of at least one polysaccharide. These weight percentages are for the total polysaccharide concentration present in the remediation composition, i.e. counting all polysaccharides in aggregate.

In some embodiments, the remediation composition comprises from about 3 wt % to about 60 wt % of at least one metal oxide, such as from about 10 wt % to about 50 wt % of at least one metal oxide, or from about 20 wt % to about 45 wt % of at least one metal oxide, or from about 28 wt % to about 40 wt % of at least one metal oxide. These weight percentages are for the total metal oxide concentration present in the remediation composition, i.e. counting all metal oxides in aggregate.

In certain embodiments, there are at least two distinct metal oxides in the remediation composition. In these embodiments, the remediation composition may comprise from about 0.1 wt % to about 60 wt % of each metal oxide, such as from about 5 wt % to about 50 wt % of each metal oxide, or from about 10 wt % to about 25 wt % of each metal oxide. The concentration of each metal oxide may be independently selected.

When there are two metal oxides in the remediation composition (e.g., magnesium oxide and aluminum oxide), the weight ratio of metal oxides may from about 0.1 to about 10, such as from about 0.2 to about 2, or from about 0.3 to about 1.2, or from about 0.4 to about 0.8.

In some embodiments, the remediation composition comprises from about 4 wt % to about 80 wt % of at least one metal salt, such as from about 10 wt % to about 75 wt % of at least one metal salt, or from about 25 wt % to about 65 wt % of at least one metal salt, or from about 34 wt % to about 54 wt % of at least one metal salt. These weight percentages are for the total metal salt concentration present in the remediation composition, i.e. counting all metal salts in aggregate.

Generally, polysaccharides may be selected from chitosan, starch, cellulose, hemicellulose, nanocellulose, polyglucan, glycogen, chitin, glucose oligomers, xylose oligomers, or combinations thereof. A composite mixture of polysaccharides may be employed, such as pretreated biomass that contains cellulose and hemicellulose.

In some embodiments, at least one polysaccharide is chitosan. Chitosan is a linear polysaccharide composed of randomly distributed β-(1→4)-linked D-glucosamine (deacetylated unit) and N-acetyl-D-glucosamine (acetylated unit). Chitosan may be prepared by treating the chitin shells of crustaceans (e.g., shrimp) with an alkaline substance, such as sodium hydroxide.

In some embodiments, at least one metal oxide is magnesium oxide (MgO). In some embodiments, at least one metal oxide is aluminum oxide (Al₂O₃). In some embodiments, at least one metal oxide is silicon oxide (SiO₂). Silicon is considered a metal for purposes of this disclosure. In certain embodiments, there are at least two metal oxides including magnesium oxide and aluminum oxide. In certain embodiments, there are at least two metal oxides including magnesium oxide and silicon oxide. In certain embodiments, there are at least three metal oxides including magnesium oxide, aluminum oxide, and silicon oxide. In these or other embodiments, at least one metal salt is sodium sulfate.

Generally, metal oxides may be selected from magnesium oxide, iron oxide, aluminum oxide, titanium oxide, calcium oxide, silicon oxide, or combinations thereof. A composite mixture of metal oxides may be employed, such as (but not limited to) diatomaceous earth (DE) which is mostly SiO₂, Al₂O₃, and Fe₂O₃. A combination of magnesium oxide and aluminum oxide is especially preferred.

Generally, metal salts may be selected from sodium sulfate, potassium sulfate, magnesium sulfate, calcium sulfate, sodium chloride, sodium fluoride, sodium bromide, sodium formate, sodium acetate, sodium bicarbonate, sodium carbonate, sodium amide, or combinations thereof. A composite mixture of metal salts may be employed. In some preferred embodiments, metal salts are selected from sodium salts and/or from metal sulfate salts. Sodium sulfate is especially preferred.

Some variations of the invention provide a remediation composition for pesticide and/or heavy-metal remediation of a biomass extract, the remediation composition comprising:

at least one polysaccharide;

at least one metal oxide, and optionally at least two distinct metal oxides; and

sodium sulfate.

Some variations of the invention provide a remediation composition for pesticide and/or heavy-metal remediation of a biomass extract, the remediation composition comprising:

chitosan;

magnesium oxide;

aluminum oxide; and

at least one metal salt.

Some variations of the invention provide a remediation composition for pesticide and/or heavy-metal remediation of a biomass extract, the remediation composition comprising:

chitosan;

magnesium oxide;

aluminum oxide; and

sodium sulfate.

Certain variation of the invention provides a remediation composition for pesticide and/or heavy-metal remediation of a biomass extract, the remediation composition comprising:

about 17 wt % to about 27 wt % chitosan;

about 8 wt % to about 18 wt % magnesium oxide;

about 16 wt % to about 26 wt % aluminum oxide; and

about 34 wt % to about 54 wt % sodium sulfate.

A specific variation of the invention provides a remediation composition for pesticide and/or heavy-metal remediation of a biomass extract, the remediation composition comprising:

about 22 wt % chitosan;

about 13 wt % magnesium oxide;

about 21 wt % aluminum oxide; and

about 44 wt % sodium sulfate.

A person skilled in the chemical arts may conduct experiments to determine the optimal concentrations of each component for a given biomass feedstock and biomass extract. Design of experiments, using statistical principles, may be employed to investigate the influence of changing concentrations as well as multi-factor interactions involving two or more components of the remediation composition.

The different components of the remediation composition are preferably mixed together to achieve a homogeneous composition with relatively uniform concentrations throughout the composition. If the remediation composition is not homogeneous, the ability to remove pesticides and heavy metals may be decreased due to reduced synergy between the different components.

Mixing may be accomplished using known apparatus, such as (but by no means limited to) paddle mixers, ribbon blenders, tumbling mixers, dispersers, high-shear mixers, multi-shaft mixers, planetary mixers, vertical blenders, static mixers, or homogenizers. Mixing may be continuous, semi-continuous, or in batch. Mixing may be carried out at room temperature (e.g., 25° C.) or at elevated temperatures (e.g., about 30° C. to 100° C.). Known statistical principles may be used to determine an effective mixing time in order to achieve a homogeneous mixture.

The particles sizes of the polysaccharide, the metal oxide(s), and the metal salt may vary but will generally be selected in the range of about 0.1 micron to about 1000 microns. A typical particle size is about 1 micron to about 50 microns. In various embodiments, each of the polysaccharide, the metal oxide(s), and the metal salt have average particle sizes that are about, at least about, or at most about 0.1, 0.5, 1, 2, 3, 4, 5, 10, 15, 20, 25, 50, 75, 100, 150, 200, 250, 300, 400, 500, 600, 700, 800, 900, or 1000 microns, including all intervening ranges. In certain embodiments, the polysaccharide, the metal oxide(s), and the metal salt have similar average particle sizes, such as each being in the range of about 1 micron to about 10 microns, or each being in the range of about 10 microns to about 100 microns, for example.

In some embodiments, the polysaccharide, metal oxide, and metal salt remain as physically distinct particles in the remediation composition. In this case, the individual particles may be identified by compositional analysis (e.g., X-ray photoelectron spectroscopy or energy dispersive X-ray spectroscopy) and average particle sizes for each of the polysaccharide, metal oxide, and metal salt may be identified.

In some embodiments, the polysaccharide, metal oxide, and metal salt form physically integrated particles, such as via powder compaction or pellet formation, such that individual particles contain the polysaccharide, the metal oxide, and the metal salt. There may be chemical bonding among the polysaccharide, the metal oxide, and the metal salt within the physically integrated particles. When there are physically integrated particles containing the polysaccharide, the metal oxide, and the metal salt, the average particle size of the particles may be selected in the range of about 1 micron to about 5000 microns, such as from about 5 microns to about 2000 microns, or from about 10 microns to about 1000 microns. In various embodiments, the average particle size of the physically integrated particles is about, at least about, or at most about 0.5, 1, 2, 3, 4, 5, 10, 15, 20, 25, 50, 75, 100, 150, 200, 250, 300, 400, 500, 600, 700, 800, 900, 1000, 1500, 2000, 2500, 3000, 3500, 4000, 4500, or 5000 microns, including all intervening ranges.

In certain embodiments, the polysaccharide and the metal oxide form particles that are isolated from the metal salt particles. In certain embodiments, the polysaccharide and the metal salt form particles that are isolated from the metal oxide particles. In certain embodiments, the metal oxide and the metal salt form particles that are isolated from the polysaccharide. In any of these cases in this paragraph, the particles formed from two components may have an average particle size selected in the range of about 0.5 microns to about 2500 microns, such as from about 1 micron to about 1000 microns, or from about 5 microns to about 500 microns, while the particles of the third component may be selected in the range of about 0.1 micron to about 1000 microns, for example.

Particle sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

The shape (geometry) of particles may vary, such as spheres, cylinders, pyramids, cubes, plates, sheets, fibers, rods, needles, or randomly shaped. In embodiments in which one or more of the polysaccharide, the metal oxide, and the metal salt are physically isolated and distinct from other components, each component may have an independent selected shape. As just one example, metal oxides and metal salts could be physically integrated (and possibly chemically bonded) in the form of fine, approximately spherical particles, while the polysaccharide is in the form of fibers with relatively long length-to-width ratio (e.g., at least 5 or at least 10).

Some variations of the invention provide a separation media comprising a remediation composition as disclosed herein. The separation media may consist essentially of the remediation composition. Alternatively, the separation media may further comprise an inert material. Alternatively, or additionally, the separation media may further comprise a support material. Alternatively, or additionally, the separation media may further comprise a spacer material.

The separation media may be a fine powder or larger particles, such as pellets, which may be fabricated with additional materials besides the polysaccharide(s), metal oxide(s), and metal salt(s) of the composition for pesticide and/or heavy-metal remediation of a biomass extract. The average particle size of the separation media may be selected in the range of about 1 micron to about 10 millimeters, such as from about 5 microns to about 5 millimeters, or from about 10 microns to about 1000 microns. In various embodiments, the average particle size of the separation media is about, at least about, or at most about 1, 2, 3, 4, 5, 10, 15, 20, 25, 50, 75, 100, 150, 200, 250, 300, 400, 500, 600, 700, 800, 900, or 1000 microns, or 1, 2, 3, 4, 5, 6, 7, 8, 9, or 10 millimeters, including all intervening ranges.

The biomass extract that is remediated by the remediation composition may include plant extracts such as hemp extract; flower extract such as hops extract, chamomile extract, dandelion extract, echinacea extract, marigold extract, or lavender extract; fruit extracts such as jujube extract; berry extracts such as blueberry extracts; grass extracts such as lemongrass extracts; and grain extracts such as rice bran extracts. See Proestos, “The Benefits of Plant Extracts for Human Health”, Foods 2020, 9, 1653, which is hereby incorporated by reference herein, for various types of biomass extracts that may be remediated using the principles taught herein.

Some variations provide a process for producing a biomass extract from a biomass feedstock, the process comprising:

(a) providing a starting biomass feedstock, wherein the starting biomass feedstock contains at least one pesticide or at least one heavy metal;

(b) exposing the starting biomass feedstock to a process solvent, thereby forming a biomass extract and residual solids, wherein the biomass extract is dissolved and/or suspended in the process solvent, and wherein at least one pesticide or at least one heavy metal are contained in the biomass extract;

(c) providing a separation media comprising a remediation composition containing at least one polysaccharide, at least one metal oxide, and at least one metal salt;

(d) introducing the biomass extract to the separation media, wherein at least one pesticide or at least one heavy metal is at least partially removed by the separation media via adsorption, absorption, precipitation, reaction, or a combination thereof, thereby generating a remediated biomass extract; and

(e) recovering the remediated biomass extract.

In some embodiments, the process solvent is a non-polar solvent, such as a hydrocarbon or supercritical carbon dioxide. A hydrocarbon solvent may be selected from the group consisting of propane, isobutane, n-hexane, cyclohexane, cyclohexene, toluene, xylenes, vegetable oils, and combinations thereof, for example. Dilution gases may be included with the process solvent. For example, inert gases such as Ar or N₂ may be present. A pump, such as a centrifugal pump, a positive-displacement pump, an axial-flow pump, etc., may be used to introduce the process solvent in step (b).

Selection of temperature and pressure in step (b) will generally depend on the desired product(s) and choice of solvent.

In some embodiments, the extraction pressure in step (b) is selected from about 1 bar to about 500 bar. In various embodiments, the extraction pressure is about, at least about, or at most about 1, 2, 3, 4, 5, 10, 15, 20, 25, 30, 40, 50, 60, 70, 80, 90, 100, 150, 200, 250, 300, 350, 400, 450, or 500 bar, for example.

The extraction time in step (b) may be from about 0.1 minute to about 1 hour, for example. In various embodiments, the extraction time is about, at least about, or at most about 0.1, 0.2, 0.3, 0.4, 0.5, 1, 2, 3, 4, 5, 10, 15, 20, 25, 30, 40, 50, or 60 minutes, for example. The extraction time refers to the amount of time needed for the extraction to take place, once the extraction pressure and temperature are reached.

Step (b) may be carried out at an extraction temperature from about 25° C. to about 100° C., for example. In various embodiments, the extraction temperature is about, at least about, or at most about 25° C., 30° C., 40° C., 50° C., 55° C., 60° C., 65° C., 70° C., 80° C., 90° C., or 95° C.

In some embodiments, the separation media is introduced to an extraction reactor configured for carrying out step (b). In these or other embodiments, the separation media is introduced to a separation unit that is distinct from an extraction reactor configured for carrying out step (b). The separation media may form a fixed bed or a fluidized bed within the separation unit. A fixed bed may be a packed bed of the separation media or structured packing, for example.

Step (d) may be conducted in the presence of at least a portion of the residual solids. In some embodiments, step (d) is conducted in the absence of the residual solids. Step (d) may be continuous or semi-continuous.

In step (d), adsorption, absorption, precipitation, and/or reaction may be associated with flow around particles, flow through particles, or a combination thereof. Typically, when relatively non-porous components are utilized in the separation media, flow will be primarily around particles such that adsorption, absorption, precipitation, and/or reaction takes places at particle surfaces to bind pesticides or heavy metals. In some embodiments which employ porous components in the separation media, such as a porous chitosan sponge, there may be flow through pores of particles such that adsorption, absorption, precipitation, and/or reaction takes places at internal pore surfaces to bind pesticides or heavy metals. Adsorption, absorption, precipitation, and/or reaction may take place both at particle surfaces as well as within internal pores.

Without being limited to any particular hypothesis, it is believed that the adsorption, absorption, precipitation, or reaction of a pesticide or heavy metal is usually mass-transfer-limited rather than kinetically limited. That is, the rate-limiting step is the mass transport of pesticide or heavy metal through the solvent to reach the composition surface, at which point pesticide or heavy metal instantly binds to the surface. The binding kinetics will depend on conditions such as temperature, pressure, and pH, so in some circumstances the binding rate may be slower than the mass-transfer rate.

Adsorption, absorption, or a combination thereof may be referred to as “sorption”. In some embodiments, binding of pesticides or heavy metals takes place via sorption only. In some embodiments, binding of pesticides or heavy metals takes place via a combination of sorption and reaction, or a combination of sorption and precipitation. In some embodiments, binding of pesticides or heavy metals takes place via a reaction or precipitation. When there is precipitation, the pesticides or heavy metals may be part of a solid phase that is bound to the remediation composition. It is also possible, in the case of precipitation, that the pesticides or heavy metals precipitate out of the solvent phase and into another liquid phase that forms a thin film at the surface of the remediation composition. Then, within the thin liquid film, a pesticide or heavy metal may diffuse to the solid surface and adsorb, for example.

The binding mechanisms for pesticides may be the same as those for heavy metals, or they may be different. Also, without being limited by speculation, the specific mechanism of binding may vary with component in the remediation composition. For example, each of the polysaccharide, metal oxide, and metal salt may primarily be associated with a distinct binding mechanism. Alternatively, or additionally, there may be one or more mechanisms of binding that cannot be distinguished at the level of individual components due to complex interactions taking place at the molecular level. An example of such synergy is trapping or bridging of a pesticide between two components of the remediation composition.

When a reaction mechanism is involved, there may be a bond formed between (a) a pesticide or a heavy metal and (b) the remediation composition, such as a hydrogen bond or an ionic bond. Alternatively, or additionally, a pesticide may undergo chemical reactions such that the pesticide decomposes into organic fragments which themselves bind to the surface, or potentially small fragments or gases (e.g., CO₂) that enter a vapor phase. These decomposition reactions may be catalyzed by one or more components of the remediation composition.

It is also possible for one or more of the remediation components to react during binding with a pesticide or heavy metal. For example, the polysaccharide may undergo reaction to replace an —OH group with another functional group. As another example, a metal oxide may react to form a metal hydroxide, nitride, carbide, hydride, sulfide, ion, salt, or zero-valent metal, for example. A metal salt may react to form an acid, base, ion, different salt, or zero-valent metal, for example.

In preferred embodiments, the pesticides or heavy metals that are removed from the liquid phase are permanently fixed to the remediation composition. By “permanently fixed” it is meant that the pesticides or heavy metals become irreversibly bound to the remediation composition while the extract is being remediated. It will be recognized that, following a production run, permanently fixed pesticides or heavy metals may be removed by thermal destruction or other means, if desired, or may remain fixed to the spent remediation composition such as when it is disposed in a landfill.

In some processes, at least one pesticide or at least one heavy metal is at least 90% removed by the separation media. That is, at least 90% of a selected pesticide or heavy metal is permanently fixed to the remediation composition. Preferably, at least one pesticide or at least one heavy metal is at least 95% or at least 99% removed by the separation media. More preferably, at least one pesticide or at least one heavy metal is completely removed by the separation media. In some embodiments, at least one pesticide and at least one heavy metal are at least 90%, at least 95%, at least 99%, or completely removed by the separation media. In some embodiments, at least 90% of total pesticides, along with at least 90% of all heavy metals (chromium, arsenic, cadmium, mercury, and lead) are removed by the separation media. In preferred embodiments, at least 99% of total pesticides, along with at least 99% of all heavy metals (chromium, arsenic, cadmium, mercury, and lead) are removed by the separation media.

Other impurities or contaminants may be removed by the remediation composition as well, besides pesticides and heavy metals. For example, during remediation, the remediation composition may remove or deactivate dirt, dust, ash, carbon, color bodies, bacteria, yeasts, fungi, mycotoxins, or other materials.

The remediation composition utilized in the process may be any one of the compositions disclosed herein. The separation media utilized in the process may be any one of the separation media disclosed herein.

In some processes, the starting biomass feedstock is hemp. In some processes, the starting biomass feedstock is hops. Many other feedstocks may be processed, as noted earlier.

The residual solids generated during the process may be collected from the extraction vessel (step (b)) and may be combusted to generate energy, composted as a soil amendment, utilized as animal feed, or used for other purposes.

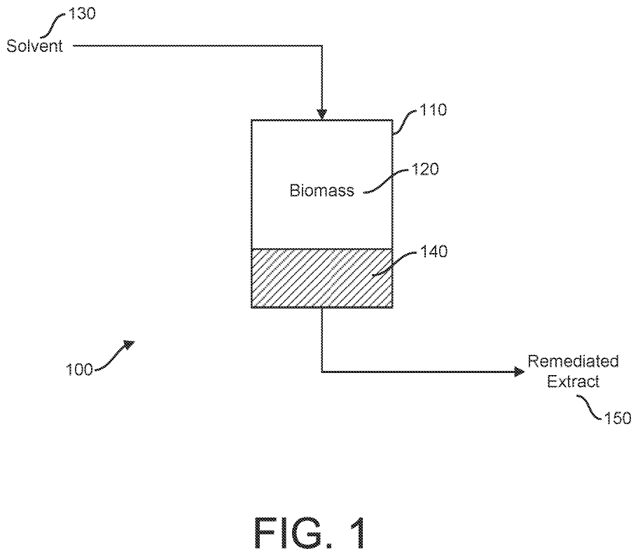

FIG. 1 depicts the process 100 of some embodiments in which a remediation composition 140 is contained within an extraction vessel 110. A solvent 130 is introduced to the extraction vessel 110 which contains biomass 120 as well as remediation composition 140. The output of the extraction vessel 110 is a remediated extract 150.

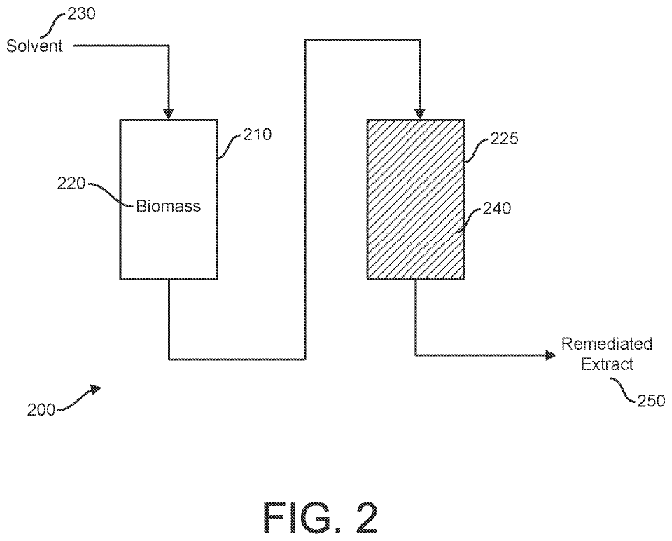

FIG. 2 depicts the process 200 of some embodiments in which a remediation composition 240 is contained within a separation vessel 225 that is downstream of an extraction vessel 210. A solvent 230 is introduced to the extraction vessel 210 which contains biomass 220. The output of the extraction vessel 210 is the input to the separation vessel 225. The separation vessel 225 contains the remediation composition 240. The remediation composition 240 is depicted as being within the entire volume of the separation vessel 225, but in other embodiments, the remediation composition 240 is contained in a portion (such as the bottom region) of the separation vessel 225. The separation vessel 225 may contain a fixed bed or a fluidized bed of the remediation composition 240. The output of the separation vessel 225 is a remediated extract 250.

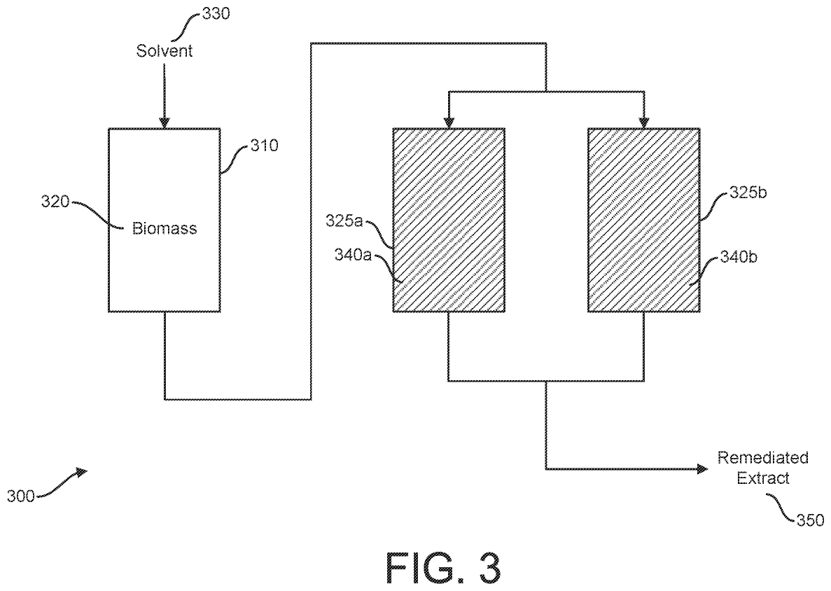

FIG. 3 depicts the process 300 of some embodiments which utilize one or more large supercritical carbon dioxide extractors. In these embodiments, at least one extraction vessel 310 is loaded with plant biomass 320. Two media vessels 325a/325b are each loaded with the remediation composition 340a/340b. A solvent 330 is introduced to the extraction vessel 310 which contains biomass 320. The output of the extraction vessel 310 is the input to one of the media vessels 325a/325b. The separation vessel 325a contains the remediation composition 340a. The separation vessel 325b contains the remediation composition 340b. The remediation composition 340a/340b is depicted as being within the entire volume of the media vessels 325a/325b, but in other embodiments, the remediation composition 340a/340b is contained in a portion (such as the bottom region) of the media vessel 325a/325b. The media vessels 325a/325b may contain a fixed bed or a fluidized bed of the remediation composition 340a/340b. The output of the media vessels 325a/325b is a remediated extract 350. One media vessel 325a or 325b is intended to be on-line while the other media vessel 325b or 325a is off-line, allowing extraction of biomass to take place essentially continuously. Also, this configuration utilizes a larger volume of media per unit of biomass, prolonging the time until the remediation composition becomes spent (no longer effective) and needs to be replaced.

Some variations of the invention provide a system for producing a biomass extract from a biomass feedstock, the system comprising:

an extraction reactor configured for exposing a starting biomass feedstock to a process solvent, thereby forming a biomass extract and residual solids, wherein the starting biomass feedstock contains at least one pesticide or at least one heavy metal;

a separation unit containing a separation media, wherein the separation unit is in flow communication with the extraction reactor, wherein the separation media comprises a composition containing at least one polysaccharide, at least one metal oxide, and at least one metal salt, and wherein the separation media is capable of at least partially removing at least one pesticide or at least one heavy metal; and

an outlet for recovering the biomass extract.

In some systems, the separation media is configured as a fixed bed within the separation unit. The fixed bed may be a packed bed of the separation media. The fixed bed may have a support structure, such as a wire mesh or fabric layer, above and/or below the fixed bed. Alternatively, or additionally, the fixed bed may be structured packing of the separation media. Structured packing may take many forms. For example, monoliths with straight channels or foam monoliths with tortuous paths may be employed. An example is α-Al₂O₃ foam monoliths with additional species incorporated into the walls during fabrication, or with channels that contain a powder of a polysaccharide, a metal salt, and optionally another metal oxide besides the α-Al₂O₃. There may be multi-layered packing that forms a plurality of channels. There may be plates or gauzes as the structured packing. Porous pellets may be utilized.

In some systems, the separation media is configured as a fluidized bed within the separation unit. A “fluidized bed” of separation media means that at least a portion of the solids are in a state of fluidization due to a fluidizing medium. The fluidizing medium may be a vapor, a liquid, or a combination thereof. Examples of fluidizing medium vapors include, but are not limited to, air, nitrogen, carbon dioxide, water (steam), or a combination thereof. Examples of fluidizing medium liquids include, but are not limited to, water and compressed carbon dioxide. The fluidizing medium may be a supercritical fluid, such as supercritical carbon dioxide (sCO₂).

In certain embodiments, a solvent for the biomass extract is utilized as a fluidizing medium liquid. For example, an organic solvent containing dissolved biomass extract may be fed to the separation unit that contains separation media. The flow rate of solvent containing dissolved biomass extract may be selected to cause fluidization of the separation media. Within the fluidized bed, the separation media removes pesticides and/or heavy metals from the biomass extract. Downstream of the separation unit, or at a later time in the case of a batch process, remediated biomass extract may be separated from solvent which may be recycled to the separation unit, to aid in fluidization of the bed of separation media.

In certain embodiments, carbon dioxide (CO₂) is utilized both as a solvent (for the biomass extract) and as a fluidizing medium (for fluidizing the separation media). It can be efficient and convenient to employ the same species as both solvent and fluidizing medium. CO₂ is an especially preferred species in this regard. Compressed, subcritical CO₂ or supercritical CO₂ may be utilized as a dual solvent and fluidizing medium. In certain embodiments, some CO₂ (solvent) enters the separation unit along with biomass extract, and an additional amount of CO₂ is fed to the separation unit to achieve a fluid velocity sufficient to achieve a fluidized bed. The thermodynamic state of each CO₂ may vary prior to entering the separation unit; for example, the solvent may be supercritical CO₂ while the injected CO₂ is a subcritical gas. Depending on the temperature and pressure profile in the separation unit, some CO₂ gas may become supercritical, or some supercritical CO₂ may become subcritical, converting to a vapor or a liquid, usually dictated by thermodynamic equilibrium.

Another exemplary embodiment employs an organic solvent, such as n-decane, for the biomass extract that is fed to a separation unit. The separation unit, in turn, is fluidized by CO₂ or N₂ gas that is separately fed to the separation unit, or potentially combined with the biomass extract solution prior to being co-fed to the separation unit. In this embodiment, some amount of solvent stripping may occur such organic solvent (e.g., n-decane) enters the vapor phase and might aid fluidization of the separation media.

Many types of fluidized beds may be employed, including particulate fluidized beds, bubbling fluidized beds, circulating fluidized beds, vibratory fluidized beds, and annular fluidized beds, for example. In some embodiments, entrained particles of separation media are recirculated via an external loop back into the fluidized bed.

Upflow of biomass extract through a fluidized bed is preferred, in the case of a vertical vessel. Recirculation of the fluidizing medium through the fluidized bed may be employed, in order to reach sufficient high fluid velocities. In can also be beneficial to use a relatively tall and narrow vessel for the separation unit, when a fluidized bed is to be maintained, because such a geometry gives higher velocities at fixed vessel volume. One skilled in the art is able to design an effective fluidized bed based on engineering and physics calculations.

The composition utilized in the system may be any one of the compositions disclosed herein. The separation media utilized in the system may be any one of the separation media disclosed herein.

In some systems, the starting biomass feedstock is hemp. In some systems, the starting biomass feedstock is hops. Many other feedstocks may be introduced to the system. The starting biomass feedstock is not necessarily present in the system, such as prior to the system being operated or after it has been operated. After the system has been operated for a period of time, the separation media may contain at least one pesticide or at least one heavy metal in adsorbed, absorbed, precipitated, and/or reacted form.

Other variations of the invention provide a system for producing a biomass extract from a biomass feedstock, the system comprising:

an extraction reactor configured for exposing a starting biomass feedstock to a process solvent, thereby forming a biomass extract and residual solids, wherein the starting biomass feedstock contains at least one pesticide or at least one heavy metal;

separation media contained within the extraction reactor, wherein the separation media comprises a composition containing at least one polysaccharide, at least one metal oxide, and at least one metal salt, and wherein the separation media is capable of at least partially removing at least one pesticide or at least one heavy metal; and an outlet for recovering the biomass extract.

In some systems, the separation media is configured as a fixed bed within the extraction reactor. The fixed bed may be a packed bed of the separation media. Alternatively, or additionally, the fixed bed may be structured packing of the separation media. The separation media may be contained within the extraction reactor in another form that is not a fixed bed—for example, within walls of the reactor, within a separation-media basket, or as a slurry.

In some systems, the separation media is configured as a fluidized bed within the extraction reactor. The fluidizing medium may be a vapor, a liquid, or a combination thereof. Examples of fluidizing medium vapors include, but are not limited to, air, nitrogen, carbon dioxide, water (steam), or a combination thereof. Examples of fluidizing medium liquids include, but are not limited to, water and compressed carbon dioxide. The fluidizing medium may be a supercritical fluid, such as supercritical carbon dioxide (sCO₂).

The composition utilized in the system may be any one of the compositions disclosed herein. The separation media utilized in the system may be any one of the separation media disclosed herein.

In some systems, the starting biomass feedstock is hemp. In some systems, the starting biomass feedstock is hops. Many other feedstocks may be introduced to the system. The starting biomass feedstock is not necessarily present in the system. After the system has been operated for a period of time, the separation media may contain at least one pesticide or at least one heavy metal in adsorbed, absorbed, precipitated, and/or reacted form.

The system may include a subsystem for adjusting temperature, pressure, and/or residence time within the extraction reactor. A subsystem may be configured to vary parameters during extraction, such as over a prescribed protocol, or in response to measured variables. For example, an unintended change in extraction reactor pressure may be compensated by a change in temperature and/or residence time. As another example, temperature may be maintained constant (isothermal operation) or pressure may be maintained constant (isobaric operation). The subsystem may utilize well-known control logic principles, such as feedback control and feedforward control. Control logic may incorporate results from previous experiments or production campaigns. One example of a subsystem is MasterLogic Programmable Logic Controller from Honeywell (Morris Plains, N.J., U.S.).

In some embodiments, the system further comprises a safety release line that is activated when the pressure within the extraction reactor reaches or exceeds a predetermined pressure, such as a pressure that is higher than the desired extraction pressure within the extraction reactor.

Other safety considerations may be applied to the system and methods disclosed herein. The subsystem mentioned above may include protective devices that automatically shut down the operation, when the temperature or pressure exceeds a maximum value. Practical safety-related designs may be built into the system as well. Those skilled in the art will understand how to design safe pressure vessels and systems employing them.

The present invention also provides a remediation method for removing pesticides and/or heavy-metals from a biomass extract, the method comprising:

(a) providing a biomass extract, wherein the biomass extract contains at least one pesticide or at least one heavy metal;

(b) providing a separation media comprising a composition containing at least one polysaccharide, at least one metal oxide, and at least one metal salt;

(c) introducing the separation media to a separation unit;

(d) feeding the biomass extract through the separation unit, wherein at least one pesticide or at least one heavy metal is at least partially removed by the separation media via adsorption, absorption, precipitation, reaction, or a combination thereof, thereby generating a remediated biomass extract; and

(e) recovering the remediated biomass extract from the separation unit.

In some methods, the biomass extract is obtained from a prior process of extracting a starting biomass feedstock utilizing a process solvent. In some embodiments, the biomass extract in step (a) is dissolved in an extract solvent consisting essentially of the process solvent. In other embodiments, the biomass extract in step (a) is dissolved in an extract solvent that is different than the process solvent. The extract solvent may be a non-polar solvent, such as a hydrocarbon or supercritical carbon dioxide.

The separation media may form a fixed bed within the separation unit. The fixed bed may be a packed bed of the separation media. Alternatively, or additionally, the fixed bed may be structured packing of the separation media.

The separation media may form a fluidized bed within the separation unit. The fluidizing medium may be a vapor, a liquid, or a combination thereof. Examples of fluidizing medium vapors include, but are not limited to, air, nitrogen, carbon dioxide, water (steam), or a combination thereof. Examples of fluidizing medium liquids include, but are not limited to, water and compressed carbon dioxide. The fluidizing medium may be a supercritical fluid, such as supercritical carbon dioxide (sCO₂).

Step (d) may comprise continuously or semi-continuously feeding the biomass extract through the separation unit. Alternatively, step (d) may comprise batch or semi-batch processing of the biomass extract in the separation unit.

In some methods, at least one pesticide or at least one heavy metal is at least 90% removed by the separation media. Preferably, at least one pesticide or at least one heavy metal is at least 95% or at least 99% removed by the separation media. More preferably, at least one pesticide or at least one heavy metal is completely removed by the separation media. In some embodiments, at least one pesticide and at least one heavy metal are at least 90%, at least 95%, at least 99%, or completely removed by the separation media. In some embodiments, at least 90% of total pesticides, along with at least 90% of all heavy metals (chromium, arsenic, cadmium, mercury, and lead) are removed by the separation media. In preferred embodiments, at least 99% of total pesticides, along with at least 99% of all heavy metals (chromium, arsenic, cadmium, mercury, and lead) are removed by the separation media.

In the remediation method, the composition utilized may be any one of the compositions disclosed herein. The separation media utilized in the remediation method may be any one of the separation media disclosed herein. Exemplary biomass extracts include, but are by no means limited to, hemp extracts and hops extracts.

The present invention also provides a remediation system for removing pesticides and/or heavy-metals from a biomass extract, the system comprising:

a separation unit containing a separation media, wherein the separation media comprises a composition containing at least one polysaccharide, at least one metal oxide, and at least one metal salt;

an inlet for feeding the biomass extract through the separation unit, wherein the separation media is capable of at least partially removing at least one pesticide or at least one heavy metal; and an outlet for recovering the biomass extract, wherein the outlet is disposed distally from the inlet.

The separation media may form a fixed bed within the separation unit of the system. The fixed bed may be a packed bed of the separation media. Alternatively, or additionally, the fixed bed may be structured packing of the separation media.

The separation media may form a fluidized bed within the separation unit of the system. The fluidizing medium may be a vapor, a liquid, or a combination thereof. Examples of fluidizing medium vapors include, but are not limited to, air, nitrogen, carbon dioxide, water (steam), or a combination thereof. Examples of fluidizing medium liquids include, but are not limited to, water and compressed carbon dioxide. The fluidizing medium may be a supercritical fluid, such as supercritical carbon dioxide (sCO₂).

In the remediation system, the composition present may be any one of the compositions disclosed herein. The separation media present in the remediation system may be any one of the separation media disclosed herein.

When the system is being operated for its intended purposes, the system will contain a biomass extract such as, but not limited to, a hemp extract or a hops extract.

After the system has been operated for a period of time, the separation media may contain at least one pesticide or at least one heavy metal in adsorbed, absorbed, precipitated, and/or reacted form.

Any of the systems disclosed herein may be configured to be modular or portable, if desired. A system is preferably designed using automation and process controls, as well as standard safety controls. The throughput of a system may vary widely, from small demo or semi-commercial scale to large commercial scale.

The system may be a batch apparatus, a continuous apparatus, a semi-continuous apparatus, or a combination thereof. The designs disclosed herein can be adapted using known chemical-engineering principles to any scale system for production of large, commercial volumes of products.

The selection of the materials of construction for the system will be dependent on the desired properties and should be considered on a case-by-case basis. Someone skilled in the art of material science or metallurgy will be able to select the appropriate materials for the intended use, based on the information provided in this disclosure.

### EXAMPLES

### Example 1: Remediation Composition

A remediation composition containing chitosan, sodium sulfate, magnesium oxide, and alumina is produced. Chitosan, sodium sulfate, magnesium oxide, and alumina are purchased in their anhydrous states. Six kilograms of chitosan, 12 kilograms of sodium sulfate, 3.5 kilograms of magnesium oxide, and 6 kilograms of alumina are carefully weighed out and dry-mixed together utilizing a Hobart Mixer to create a homogeneous mixture. The concentrations of these components had been determined by previous experimentation as being particularly effective at remediation.

The remediation composition is in dry-powder form with the following composition:
Chitosan 22 wt %
Magnesium Oxide 13 wt %
Sodium Sulfate 44 wt %
Alumina 21 wt %

### Example 2: Use of Remediation Composition in a Packed Column

The remediation composition of Example 1 is loaded into a packed-column apparatus. The packed column is configured such that it is capable of receiving a mixture of non-polar solvent, solutes, pesticides, and heavy metals into an inlet of the packed column. When the solvent and solutes pass through the remediation composition, one or more components of the remediation composition pull the pesticides and heavy metals out of the liquid phase. Pesticides and heavy metals become fixed to the remediation composition. The packed column is also configured with an outlet such that the pesticide-free, heavy metal-free solvent and solutes exit the packed column.

### Example 3: Use of Remediation Composition in Supercritical CO₂ Extraction of Hemp

A supercritical carbon dioxide extraction machine is utilized to facilitate the removal of pesticides and heavy metals from a known contaminated hemp extract. The hemp extract utilized is at a 55 wt % cannabidiol (CBD) concentration in a pseudo-liquid/solid state. To replicate initial plant matter, the 55 wt % mixture is diluted/mixed down with a cellulose-rich plant-based material to create a 10 wt % feed mixture.

The extraction machine contains two 320-liter high-pressure extraction vessels that each operate at 3,000 psig (206.8 bar). Each extraction vessel operates at temperatures from about 50° C. to about 60° C. with solvent flow rates from about 2,000 lb/hr (907 kg/hr) to about 2,500 lb/hr (1,134 kg/hr). The high-pressure extraction vessels are configured sequentially—the exit of the first extraction vessel is the inlet to the second extraction vessel.

The remediation composition of Example 1 is placed in the bottom of the second extraction vessel, with no extractables below. Once the remediation composition is loaded, the feed mixture is added to the rest of the empty space in both extraction vessels. The inlet of the second extraction vessel is at the top, and the outlet is at the bottom (downflow). It is important that the remediation composition is the last contact point for solutes in the carbon dioxide solution before exiting the second vessel.

After the first and second extraction vessel have been loaded, extraction of the feed mixture progresses at a temperature from about 50° C. to about 60° C., a pressure of about 3,000 psig (206.8 bar). The material exiting the second extraction vessel is remediated, i.e. the pesticides and heavy metals have been removed. After the extraction has taken place, the non-extracted biomass with the remediation media are vacuumed out and disposed of.

Table 1 below shows concentration measurements of various pesticides using Liquid Chromatography Tandem Mass Spectrometry (LC-MS/MS) and Gas Chromatography Tandem Mass Spectrometry (GC-MS/MS) of remediated hemp extract produced from contaminated hemp. For comparison, Table 1 also shows concentration measurements of various pesticides using LC-MS/MS and GC-MS/MS of non-remediated hemp extract produced from contaminated hemp, without exposure to the remediation composition of Example 1.

In addition, the contaminated hemp is analyzed for heavy metals and shown to contain cadmium, lead, and arsenic. The remediated hemp extract produced from contaminated hemp, with treatment using the remediation composition of Example 1, contains no detectible concentrations of cadmium, lead, arsenic, or mercury.

As demonstrated in this Example 3, all of the pesticides and heavy metals are removed after treatment with the remediation composition. The remediation composition is surprisingly effective and reveals an unexpected synergy among chitosan, sodium sulfate, magnesium oxide, and alumina for removing pesticides and heavy metals.

TABLE 1
Concentration of Pesticides Measured With
LC-MS/MS and GC-MS/MS of Non-Remediated Hemp
Extract Versus Remediated Hemp Extract.

| | | Non- | |
|---|---|---|---|
| | LOD/LOQ | Remediated | Remediated |
| Analyte | (μg/g)* | (μg/g) | (μg/g) |
| Abamectin | 0.04/0.10 | 0 | 0 |
| Acephate | 0.04/0.10 | 0 | 0 |
| Acequinocyl | 0.04/0.10 | 0 | 0 |
| Acetamiprid | 0.04/0.10 | 0 | 0 |
| Aldicarb | 0.04/0.10 | 0 | 0 |
| Azoxystrobin | 0.04/0.10 | 0 | 0 |
| Bifenazate | 0.04/0.10 | 0 | 0 |
| Bifenthrin | 0.20/0.50 | 0 | 0 |
| Boscalid | 0.04/0.10 | 0 | 0 |
| Captan | 0.25/0.70 | 0 | 0 |
| Carbaryl | 0.20/0.50 | 0 | 0 |
| Carbofuran | 0.04/0.10 | 0 | 0 |
| Chlorantraniliprole | 0.04/0.10 | 0 | 0 |
| Chlordane | 0.04/0.10 | 0 | 0 |
| Chlorfenapyr | 0.04/0.10 | 0 | 0 |
| Chlorpyrifos | 0.04/0.10 | 0 | 0 |
| Clofentezine | 0.04/0.10 | 0 | 0 |
| Coumaphos | 0.04/0.10 | 0 | 0 |
| Cyfluthrin | 0.70/2.00 | 0 | 0 |
| Cypermethrin | 0.35/1.00 | 0 | 0 |
| Daminozide | 0.04/0.10 | 0 | 0 |
| DDVP (Dichlorvous) | 0.04/0.10 | 0 | 0 |
| Diazinon | 0.04/0.10 | 0 | 0 |
| Dimethoate | 0.04/0.10 | 0 | 0 |
| Dimethomorph | 0.04/0.10 | 0 | 0 |
| Ethoprop(hos) | 0.04/0.10 | 0.0352 | 0 |
| Etofenprox | 0.04/0.10 | 0 | 0 |
| Etoxazole | 0.04/0.10 | 0 | 0 |
| Fenhexamid | 0.04/0.10 | 0 | 0 |
| Fenoxycarb | 0.04/0.10 | 0 | 0 |
| Fenpyroximate | 0.04/0.10 | 0 | 0 |
| Fipronil | 0.04/0.10 | 0 | 0 |
| Flonicamid | 0.04/0.10 | 0 | 0 |
| Fludioxanil | 0.04/0.10 | 0 | 0 |
| Hexythiazox | 0.04/0.10 | 0 | 0 |
| Imazalil | 0.04/0.10 | 0 | 0 |
| Imidacloprid | 0.04/0.10 | 0 | 0 |
| Kresoxim Methyl | 0.04/0.10 | 0 | 0 |
| Malathion | 0.20/0.50 | 0 | 0 |
| Metalaxyl | 0.04/0.10 | 0 | 0 |
| Methiocarb | 0.04/0.10 | 0 | 0 |
| Methomyl | 0.04/1.00 | 0 | 0 |
| Methyl parathion | 0.04/0.10 | 0 | 0 |
| Mevinphos | 0.04/0.10 | 0 | 0 |
| Myclobutanil | 0.04/0.10 | 0 | 0 |
| Naled | 0.50/1.50 | 0 | 0 |
| Oxamyl | 0.20/0.50 | 0 | 0 |
| Paclobutrazol | 0.04/0.10 | 0 | 0 |
| Pentachloronitrobenzene | 0.04/0.10 | 0 | 0 |
| Permethrins | 0.20/0.50 | 0 | 0 |
| Phosmet | 0.04/0.10 | 0 | 0 |
| Piperonyl Butoxide | 0.04/0.10 | 0 | 0 |
| Prallethrin | 0.50/1.50 | 0 | 0 |
| Propiconazole | 0.04/0.10 | 0 | 0 |
| Propoxur | 0.04/0.10 | 0 | 0 |
| Pyrethrins | 0.20/0.50 | 0 | 0 |
| Pyridaben | 0.04/0.10 | 0 | 0 |
| Spinetoram | 0.04/0.10 | 0 | 0 |
| Spinosad | 0.04/0.10 | 0 | 0 |
| Spiromesifen | 0.04/0.10 | 0 | 0 |
| Spirotetramat | 0.04/0.10 | 0 | 0 |
| Spiroxamine | 0.04/0.10 | 0 | 0 |
| Tebuconazole | 0.04/0.10 | 0 | 0 |
| Thiaclorprid | 0.04/0.10 | 0 | 0 |
| Thiamethoxam | 0.35/1.00 | 0 | 0 |
| Trifloxystrobin | 0.04/0.10 | 0 | 0 |
| Acetochlor | 0.04-0.20/0.1-0.5 | 0 | 0 |
| Alachlor | 0.04-0.20/0.1-0.5 | 0 | 0 |
| Aldicarb Sulfone | 0.04-0.20/0.1-0.5 | 0 | 0 |
| Aldicarb sulfoxide | 0.04-0.20/0.1-0.5 | 0 | 0 |
| Aldrin | 0.04-0.20/0.1-0.5 | 0 | 0 |
| Atrazine | 0.04-0.20/0.1-0.5 | 0 | 0 |
| Benfluralin | 0.04-0.20/0.1-0.5 | 0 | 0 |
| BHC alpha | 0.04-0.20/0.1-0.5 | 0 | 0 |
| BHC beta | 0.04-0.20/0.1-0.5 | 0 | 0 |
| Bitertanol | 0.04-0.20/0.1-0.5 | 0 | 0 |
| Buprofezin | 0.04-0.20/0.1-0.5 | 0 | 0 |
| Carbendazim (MBC) | 0.04-0.20/0.1-0.5 | 0 | 0 |
| Carfentrazone ethyl | 0.04-0.20/0.1-0.5 | 0 | 0 |
| Chlorobenzilate | 0.04-0.20/0.1-0.5 | 0 | 0 |
| Chlorotoluron | 0.04-0.20/0.1-0.5 | 0 | 0 |
| Chlorpropham | 0.04-0.20/0.1-0.5 | 0.372 | 0 |
| Chlorpyrifos methyl | 0.04-0.20/0.1-0.5 | 0 | 0 |
| Chlorthiophos | 0.04-0.20/0.1-0.5 | 0 | 0 |
| Clethodim | 0.04-0.20/0.1-0.5 | 0 | 0 |
| Clomazone | 0.04-0.20/0.1-0.5 | 0 | 0 |
| Clothianidin | 0.04-0.20/0.1-0.5 | 0 | 0 |
| Cyazofamid | 0.04-0.20/0.1-0.5 | 0 | 0 |
| Cymoxanil | 0.04-0.20/0.1-0.5 | 0 | 0 |
| Cyprodinil | 0.04-0.20/0.1-0.5 | 0 | 0 |
| Cyromazine | 0.04-0.20/0.1-0.5 | 0 | 0 |
| DCPA (Dacthal) | 0.04-0.20/0.1-0.5 | 0 | 0 |
| Diallate | 0.04-0.20/0.1-0.5 | 0 | 0 |
| Dieldrin | 0.04-0.20/0.1-0.5 | 0 | 0 |
| Diflubenzuron | 0.04-0.20/0.1-0.5 | 0 | 0 |
| Dimethachlor | 0.04-0.20/0.1-0.5 | 0 | 0 |
| Diniconazole | 0.04-0.20/0.1-0.5 | 0 | 0 |
| Dinotefuran | 0.04-0.20/0.1-0.5 | 0 | 0 |
| Diphenamid | 0.04-0.20/0.1-0.5 | 0.102 | 0 |
| Diphenylamine (DPA) | 0.04-0.20/0.1-0.5 | 0 | 0 |
| Diuron | 0.04-0.20/0.1-0.5 | 0 | 0 |
| Esfenvalerate | 0.04-0.20/0.1-0.5 | 0 | 0 |
| Ethalfluralin | 0.04-0.20/0.1-0.5 | 0 | 0 |
| Ethylan | 0.04-0.20/0.1-0.5 | 0 | 0 |
| Etridazole | 0.04-0.20/0.1-0.5 | 0 | 0 |
| Fenarimol | 0.04-0.20/0.1-0.5 | 0 | 0 |
| Fenbuconazole | 0.04-0.20/0.1-0.5 | 0 | 0 |
| Fenpropimorph | 0.04-0.20/0.1-0.5 | 0 | 0 |
| Fenthion | 0.04-0.20/0.1-0.5 | 0 | 0 |
| Fenvalerate | 0.04-0.20/0.1-0.5 | 0 | 0 |
| Fluazifop-P-butyl | 0.04-0.20/0.1-0.5 | 0 | 0 |
| Flubendiamide | 0.04-0.20/0.1-0.5 | 0 | 0 |
| Fluchloralin | 0.04-0.20/0.1-0.5 | 0 | 0 |
| Flucythrinate | 0.04-0.20/0.1-0.5 | 0 | 0 |
| Fluoxastrobin | 0.04-0.20/0.1-0.5 | 0 | 0 |
| Flusilazole | 0.04-0.20/0.1-0.5 | 0 | 0 |
| Flutolanil | 0.04-0.20/0.1-0.5 | 0 | 0 |
| Flutriafol | 0.04-0.20/0.1-0.5 | 0 | 0 |
| Fonofos | 0.04-0.20/0.1-0.5 | 0 | 0 |
| Formetanate | 0.04-0.20/0.1-0.5 | 0 | 0 |
| Heptachlor | 0.04-0.20/0.1-0.5 | 0 | 0 |
| Hexachlorobenzene | 0.04-0.20/0.1-0.5 | 0 | 0 |
| Hexaconazole | 0.04-0.20/0.1-0.5 | 0 | 0 |
| Hexazinone | 0.04-0.20/0.1-0.5 | 0 | 0 |
| 3-Hydroxycarbofuran | 0.04-0.20/0.1-0.5 | 0 | 0 |
| Indoxacarb | 0.04-0.20/0.1-0.5 | 0 | 0 |
| Isazophos | 0.04-0.20/0.1-0.5 | 0 | 0 |
| Isopropalin | 0.04-0.20/0.1-0.5 | 0 | 0 |
| Isoproturon | 0.04-0.20/0.1-0.5 | 0 | 0 |
| Lindane | 0.04-0.20/0.1-0.5 | 0 | 0 |
| Linuron | 0.04-0.20/0.1-0.5 | 0 | 0 |
| Mandipropamid | 0.04-0.20/0.1-0.5 | 0 | 0 |
| Methamidophos | 0.04-0.20/0.1-0.5 | 0 | 0 |
| Methoxychlor | 0.04-0.20/0.1-0.5 | 0 | 0 |
| 4-4′-Methoxychlor olefin | 0.04-0.20/0.1-0.5 | 0 | 0 |
| Methoxyfenozide | 0.04-0.20/0.1-0.5 | 0 | 0 |
| Metolachlor | 0.04-0.20/0.1-0.5 | 0 | 0 |
| MGK 264 | 0.04-0.20/0.1-0.5 | 0 | 0 |
| Mirex | 0.04-0.20/0.1-0.5 | 0 | 0 |
| Novaluron | 0.04-0.20/0.1-0.5 | 0 | 0 |
| 5-OH Thiabendazole | 0.04-0.20/0.1-0.5 | 0 | 0 |
| Omethoate | 0.04-0.20/0.1-0.5 | 0 | 0 |
| Oxadiazon | 0.04-0.20/0.1-0.5 | 0 | 0 |
| Oxyflourfen | 0.04-0.20/0.1-0.5 | 0 | 0 |
| Parathion | 0.04-0.20/0.1-0.5 | 0 | 0 |
| Pebulate | 0.04-0.20/0.1-0.5 | 0 | 0 |
| Penconazole | 0.04-0.20/0.1-0.5 | 0 | 0 |
| Pendimethalin | 0.04-0.20/0.1-0.5 | 0.0542 | 0 |
| Pentachloroaniline | 0.04-0.20/0.1-0.5 | 0 | 0 |
| Pentachloroanisole | 0.04-0.20/0.1-0.5 | 0 | 0 |
| Pentachlorobenzene | 0.04-0.20/0.1-0.5 | 0 | 0 |
| Pentachlorobenzonitrile | 0.04-0.20/0.1-0.5 | 0 | 0 |
| 2-Phenylphenol | 0.04-0.20/0.1-0.5 | 0 | 0 |
| Pirimicarb | 0.04-0.20/0.1-0.5 | 0 | 0 |
| Pirimiphos-ethyl | 0.04-0.20/0.1-0.5 | 0 | 0 |
| Pirimiphos-methyl | 0.04-0.20/0.1-0.5 | 0 | 0 |
| Pretilachlor | 0.04-0.20/0.1-0.5 | 0 | 0 |
| Prochloraz | 0.04-0.20/0.1-0.5 | 0 | 0 |
| Procymidone | 0.04-0.20/0.1-0.5 | 0.0689 | 0 |
| Propamocarb | 0.04-0.20/0.1-0.5 | 0 | 0 |
| Propargite | 0.04-0.20/0.1-0.5 | 0 | 0 |
| Propisochlor | 0.04-0.20/0.1-0.5 | 0 | 0 |
| Propyzamide | 0.04-0.20/0.1-0.5 | 0 | 0 |
| Prothiofos | 0.04-0.20/0.1-0.5 | 0 | 0 |
| Pymetrozine | 0.04-0.20/0.1-0.5 | 0 | 0 |
| Pyraclostrobin | 0.04-0.20/0.1-0.5 | 0 | 0 |
| Pyrimethanil | 0.04-0.20/0.1-0.5 | 0 | 0 |
| Pyriproxyfen | 0.04-0.20/0.1-0.5 | 0 | 0 |
| Quinalphos | 0.04-0.20/0.1-0.5 | 0 | 0 |
| Quintozene | 0.04-0.20/0.1-0.5 | 0 | 0 |
| Sulfentrazone | 0.04-0.20/0.1-0.5 | 0 | 0 |
| Sulfotep | 0.04-0.20/0.1-0.5 | 0 | 0 |
| Tau-Fluvalinate | 0.04-0.20/0.1-0.5 | 0 | 0 |
| Tebufenozide | 0.04-0.20/0.1-0.5 | 0 | 0 |
| Tecnazene | 0.04-0.20/0.1-0.5 | 0 | 0 |
| Tefluthrin | 0.04-0.20/0.1-0.5 | 0 | 0 |
| Terbutylazine | 0.04-0.20/0.1-0.5 | 0 | 0 |
| Tetrachloroaniline | 0.04-0.20/0.1-0.5 | 0 | 0 |
| Tetradifon | 0.04-0.20/0.1-0.5 | 0 | 0 |
| Thiobencarb | 0.04-0.20/0.1-0.5 | 0 | 0 |
| Tolclofos-methyl | 0.04-0.20/0.1-0.5 | 0 | 0 |
| Transfluthrin | 0.04-0.20/0.1-0.5 | 0 | 0 |
| Triadimefon | 0.04-0.20/0.1-0.5 | 0 | 0 |
| Triallate | 0.04-0.20/0.1-0.5 | 0 | 0 |
| Trichlorfon | 0.04-0.20/0.1-0.5 | 0 | 0 |
| Tricyclazole | 0.04-0.20/0.1-0.5 | 0 | 0 |
| Triflumizole | 0.04-0.20/0.1-0.5 | 0 | 0 |
| Trifluralin | 0.04-0.20/0.1-0.5 | 0 | 0 |
| Vamidothion | 0.04-0.20/0.1-0.5 | 0 | 0 |
| Vinclozolin | 0.04-0.20/0.1-0.5 | 0 | 0 |

*LOD = limit of detection; LOQ = limit of quantification.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. A composition for pesticide and/or heavy-metal remediation of a biomass extract, said composition comprising:
at least one polysaccharide;
at least one metal oxide; and
at least one metal salt.

2. The composition of claim 1, wherein said composition consists essentially of said at least one polysaccharide, said at least one metal oxide, and said at least one metal salt.

3. The composition of claim 1, wherein said composition comprises from about 2 wt % to about 40 wt % of said at least one polysaccharide.

4. The composition of claim 1, wherein said composition comprises from about 5 wt % to about 35 wt % of said at least one polysaccharide.

5. The composition of claim 1, wherein said composition comprises from about 10 wt % to about 30 wt % of said at least one polysaccharide.

6. The composition of claim 1, wherein said composition comprises from about 17 wt % to about 27 wt % of said at least one polysaccharide.

7. The composition of claim 1, wherein said composition comprises from about 3 wt % to about 60 wt % of said at least one metal oxide.

8. The composition of claim 1, wherein said composition comprises from about 10 wt % to about 50 wt % of said at least one metal oxide.

9. The composition of claim 1, wherein said composition comprises from about 20 wt % to about 45 wt % of said at least one metal oxide.

10. The composition of claim 1, wherein said composition comprises from about 28 wt % to about 40 wt % of said at least one metal oxide.

11. The composition of claim 1, wherein said composition comprises from about 4 wt % to about 80 wt % of said at least one metal salt.

12. The composition of claim 1, wherein said composition comprises from about 10 wt % to about 75 wt % of said at least one metal salt.

13. The composition of claim 1, wherein said composition comprises from about 25 wt % to about 65 wt % of said at least one metal salt.

14. The composition of claim 1, wherein said composition comprises from about 34 wt % to about 54 wt % of said at least one metal salt.

15. The composition of claim 1, wherein said at least one metal oxide is at least two distinct metal oxides.

16. The composition of claim 1, wherein said at least one polysaccharide includes chitosan.

17. The composition of claim 1, wherein said at least one metal oxide includes magnesium oxide.

18. The composition of claim 1, wherein said at least one metal oxide includes aluminum oxide.

19. The composition of claim 1, wherein said at least one metal oxide includes silicon oxide.

20. The composition of claim 1, wherein said at least one metal oxide includes (i) magnesium oxide and (ii) aluminum oxide and/or silicon oxide.

21. The composition of claim 1, wherein said at least one metal salt includes sodium sulfate.

22. A separation media comprising the composition of claim 1.

23. The separation media of claim 22, wherein said separation media consists essentially of said composition.

24. The separation media of claim 22, wherein said separation media further comprises an inert material, a support material, a spacer material, or a combination thereof.

25. A method for removing pesticides and/or heavy-metals from a biomass extract, said method comprising:
(a) providing a biomass extract, wherein said biomass extract contains at least one pesticide or at least one heavy metal;
(b) providing a separation media comprising a composition containing at least one polysaccharide, at least one metal oxide, and at least one metal salt;
(c) introducing said separation media to a separation unit;
(d) feeding said biomass extract through said separation unit, wherein said at least one pesticide or said at least one heavy metal is at least partially removed by said separation media via adsorption, absorption, precipitation, reaction, or a combination thereof, thereby generating a remediated biomass extract; and
(e) recovering said remediated biomass extract from said separation unit.

26. The method of claim 25, wherein said biomass extract is a hemp extract.

27. The method of claim 25, wherein said biomass extract is a hops extract.

28. The method of claim 25, wherein said biomass extract is obtained from a prior process of extracting a starting biomass feedstock utilizing a process solvent.

29. The method of claim 28, wherein said biomass extract in step (a) is dissolved in an extract solvent consisting essentially of said process solvent.

30. The method of claim 28, wherein said biomass extract in step (a) is dissolved in an extract solvent that is different than said process solvent.

31. The method of claim 29, wherein said extract solvent is a non-polar solvent.

32. The method of claim 31, wherein said non-polar solvent is a hydrocarbon.

33. The method of claim 31, wherein said non-polar solvent is supercritical carbon dioxide.

34. The method of claim 25, wherein said separation media forms a fixed bed within said separation unit.

35. The method of claim 34, wherein said fixed bed is a packed bed of said separation media.

36. The method of claim 34, wherein said fixed bed is structured packing of said separation media.

37. The method of claim 25, wherein said separation media forms a fluidized bed within said separation unit.

38. The method of claim 25, wherein step (d) comprises continuously or semi-continuously feeding said biomass extract through said separation unit.

39. The method of claim 25, wherein said at least one pesticide or said at least one heavy metal is at least 90% removed by said separation media.

40. The method of claim 25, wherein said at least one pesticide or said at least one heavy metal is at least 99% removed by said separation media.

41. The method of claim 25, wherein said at least one pesticide or said at least one heavy metal is completely removed by said separation media.

42. A system for removing pesticides and/or heavy-metals from a biomass extract, said system comprising:
a separation unit containing a separation media, wherein said separation media comprises a composition containing at least one polysaccharide, at least one metal oxide, and at least one metal salt;
an inlet for feeding said biomass extract through said separation unit, wherein said separation media is capable of at least partially removing at least one pesticide or at least one heavy metal; and
an outlet for recovering said biomass extract, wherein said outlet is disposed distally from said inlet.

43. The system of claim 42, wherein said separation media is configured as a fixed bed within said separation unit.

44. The system of claim 43, wherein said fixed bed is a packed bed of said separation media.

45. The system of claim 43, wherein said fixed bed is structured packing of said separation media.

46. The system of claim 42, wherein said separation media is configured as a fluidized bed within said separation unit.

47. The system of claim 42, wherein said biomass extract is present within said separation unit.

48. The system of claim 47, wherein said biomass extract is a hemp extract.

49. The system of claim 47, wherein said biomass extract is a hops extract.

50. The system of claim 42, wherein said separation media contains said at least one pesticide or said at least one heavy metal in adsorbed, absorbed, precipitated, and/or reacted form.

51. A process for producing a biomass extract from a biomass feedstock, said process comprising:
(a) providing a starting biomass feedstock, wherein said starting biomass feedstock contains at least one pesticide or at least one heavy metal;
(b) exposing said starting biomass feedstock to a process solvent, thereby forming a biomass extract and residual solids, wherein said biomass extract is dissolved and/or suspended in said process solvent, and wherein said at least one pesticide or said at least one heavy metal are contained in said biomass extract;
(c) providing a separation media comprising a composition containing at least one polysaccharide, at least one metal oxide, and at least one metal salt;
(d) introducing said biomass extract to said separation media, wherein said at least one pesticide or said at least one heavy metal is at least partially removed by said separation media via adsorption, absorption, precipitation, reaction, or a combination thereof, thereby generating a remediated biomass extract; and
(e) recovering said remediated biomass extract.

52. The process of claim 51, wherein said process solvent is a non-polar solvent.

53. The process of claim 52, wherein said non-polar solvent is a hydrocarbon.

54. The process of claim 52, wherein said non-polar solvent is supercritical carbon dioxide.

55. The process of claim 51, wherein said separation media is introduced to an extraction reactor configured for carrying out step (b).

56. The process of claim 51, wherein said separation media is introduced to a separation unit that is distinct from an extraction reactor configured for carrying out step (b).

57. The process of claim 51, wherein said separation media forms a fixed bed within said separation unit.

58. The process of claim 57, wherein said fixed bed is a packed bed of said separation media.

59. The process of claim 57, wherein said fixed bed is structured packing of said separation media.

57. The process of claim 51, wherein said separation media forms a fixed bed within said separation unit.

58. The process of claim 51, wherein said separation media forms a fluidized bed within said separation unit.

59. The process of claim 51, wherein step (d) is conducted in the presence of at least a portion of said residual solids.

60. The process of claim 51, wherein step (d) is conducted in the absence of said residual solids.

61. The process of claim 51, wherein step (d) is continuous or semi-continuous.

62. The process of claim 51, wherein said at least one pesticide or said at least one heavy metal is at least 90% removed by said separation media.

63. The process of claim 51, wherein said at least one pesticide or said at least one heavy metal is at least 99% removed by said separation media.

64. The process of claim 51, wherein said at least one pesticide or said at least one heavy metal is completely removed by said separation media.

65. The process of claim 51, wherein said starting biomass feedstock is hemp.

66. The process of claim 51, wherein said starting biomass feedstock is hops.

67. A system for producing a biomass extract from a biomass feedstock, said system comprising:
an extraction reactor configured for exposing a starting biomass feedstock to a process solvent, thereby forming a biomass extract and residual solids, wherein said starting biomass feedstock contains at least one pesticide or at least one heavy metal;
a separation unit containing a separation media, wherein said separation unit is in flow communication with said extraction reactor, wherein said separation media comprises a composition containing at least one polysaccharide, at least one metal oxide, and at least one metal salt, and wherein said separation media is capable of at least partially removing at least one pesticide or at least one heavy metal; and
an outlet for recovering said biomass extract.

68. The system of claim 67, wherein said separation media is configured as a fixed bed within said separation unit.

69. The system of claim 68, wherein said fixed bed is a packed bed of said separation media.

70. The system of claim 68, wherein said fixed bed is structured packing of said separation media.

71. The system of claim 67, wherein said separation media is configured as a fluidized bed within said separation unit

72. The system of claim 67, wherein said separation media contains said at least one pesticide or said at least one heavy metal in adsorbed, absorbed, precipitated, and/or reacted form.

73. A system for producing a biomass extract from a biomass feedstock, said system comprising:
an extraction reactor configured for exposing a starting biomass feedstock to a process solvent, thereby forming a biomass extract and residual solids, wherein said starting biomass feedstock contains at least one pesticide or at least one heavy metal;
separation media contained within said extraction reactor, wherein said separation media comprises a composition containing at least one polysaccharide, at least one metal oxide, and at least one metal salt, and wherein said separation media is capable of at least partially removing at least one pesticide or at least one heavy metal; and
an outlet for recovering said biomass extract.

74. The system of claim 73, wherein said separation media is configured as a fixed bed within said extraction reactor.

75. The system of claim 74, wherein said fixed bed is a packed bed of said separation media.

76. The system of claim 74, wherein said fixed bed is structured packing of said separation media.

77. The system of claim 73, wherein said separation media is configured as a fluidized bed within said extraction reactor.

78. The system of claim 73, wherein said separation media contains said at least one pesticide or said at least one heavy metal in adsorbed, absorbed, precipitated, and/or reacted form.
